(19) United States
(12) Patent Application Publication
(10) Pub. No.: US 2005/0199628 A1
(43) Pub. Date: Sep. 15, 2005

(54) KEY STORAGE AND ORGANIZATION UNIT

(75) Inventors: Mark Van Handel, Milwaukee, WI (US); Michael Brojanac, Jackson, WI (US)

Correspondence Address: CALFEE HALTER & GRISWOLD, LLP, 800 SUPERIOR AVENUE, SUITE 1400, CLEVELAND, OH, 44114, US

(73) Assignee: MASTER LOCK COMPANY, Oak Creek, WI (US)

(21) Appl. No.: 10/906,952

(22) Filed: Mar. 14, 2005

Related U.S. Application Data
(60) Provisional application No. 60/521,220, filed on Mar. 12, 2004.

(51) Int. Cl. G05B 19/00

(52) U.S. Cl. 220/315; 70/63; 220/324

(57) ABSTRACT

A key storage and organization unit includes a lockbox and a set of key file cards for retaining and storing keys in an organized manner. The lockbox includes a base and a cover that are secured by two closure latching members. When the two closure latching members are applied to the base and cover, a single locking mechanism can be applied to secure the lockbox. The lockbox is designed to receive multiple locking mechanisms, each capable of securing access to the lockbox.

### CROSS-REFERENCE TO RELATED PATENT APPLICATIONS

This application claims the benefit of U.S. Provisional Patent Application No. 60/521,220 filed on Mar. 12, 2004, the entire disclosure of which is hereby incorporated by reference.

### FIELD OF THE INVENTION

The present invention is directed to a key storage and organization unit, and more specifically, a lockbox that can secure a number of keys in an organized manner with a single lock or with multiple locks.

### BACKGROUND

Keys for various objects, such as doors, equipment, or locks, are often stored in a central location so that numerous persons can obtain access to the keys. However, in some situations it is desirable to prevent people from accessing the central key storage bin. This might be the case for general security measures or for safety measures, such as when access to a locked area or piece of equipment has the potential to place someone at risk of injury. In such cases, it may be desirable to secure the central storage bin with multiple locks to ensure that each person is out of harms way prior to granting access to the keys in the central storage bin. It is also often desirable to provide a means for organizing the keys stored in the central storage bin.

FIG. 1 illustrates a prior art safety lockbox. As can be seen from the drawing, the lockbox includes a central bin and a lid that closes the central bin. Holes align on the lid and bin align to allow a lock to secure the lid to the bin. However, as shown in FIG. 1, a person can still gain access to the central bin even when a lock is applied to the lid of the central bin. In addition, the safety lockbox of FIG. 1 does not provide any means for organizing the keys storage in the central bin.

### SUMMARY OF THE INVENTION

A key storage and organization unit is provided herein. The key storage and organization unit provides a means for securing keys with a single locking mechanism or with multiple locking mechanisms. As long as at least one locking mechanism is applied, access to the keys stored in the unit is denied. In one embodiment the key storage and organization unit includes a lockbox having a base, cover and closure latching member. The key storage and organization unit may also include one or more key file cards for securing and organizing the keys being stored in the unit. In some embodiments, the cover includes a key slot that allows keys to be dropped into the unit.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below serve to illustrate the principles of this invention.

FIG. 1 is a perspective view of a prior art lockbox.

FIG. 2 is a perspective view of an embodiment of a lockbox of the present invention.

FIG. 3 is a top view of the lockbox closure mechanism.

FIG. 4 is a cross-sectional view of a lockbox in the closed position.

FIG. 5 is a cross-sectional view of a lockbox in the opened position.

FIG. 6 illustrates a key drop slot.

FIG. 7 is a cross-sectional view of the key drop slot of FIG. 6.

FIG. 8 illustrates an embodiment of a key file card.

FIG. 9 illustrates the handle portion of the key file card shown in FIG. 8.

FIG. 10 illustrates the key retention portion of the key file card.

FIG. 11 is a cross-sectional view of the key retention portion of the key file card shown in FIG. 10.

FIG. 12 is a perspective view of a second embodiment of a lockbox of the present invention.

FIG. 13 is a top view of the lockbox shown in FIG. 12.

FIG. 14 is an exploded view of the lockbox shown in FIG. 12.

FIG. 15 illustrates a second embodiment of a key file card.

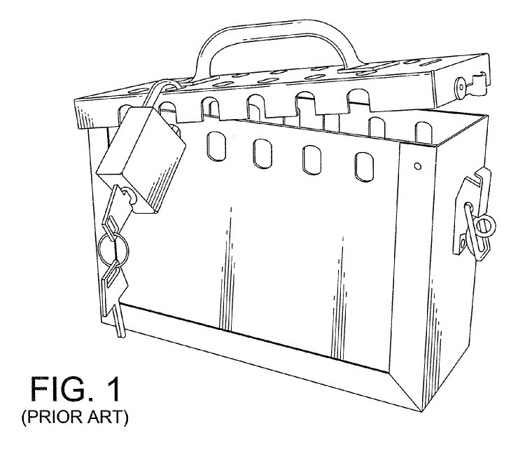

### DESCRIPTION OF THE INVENTION

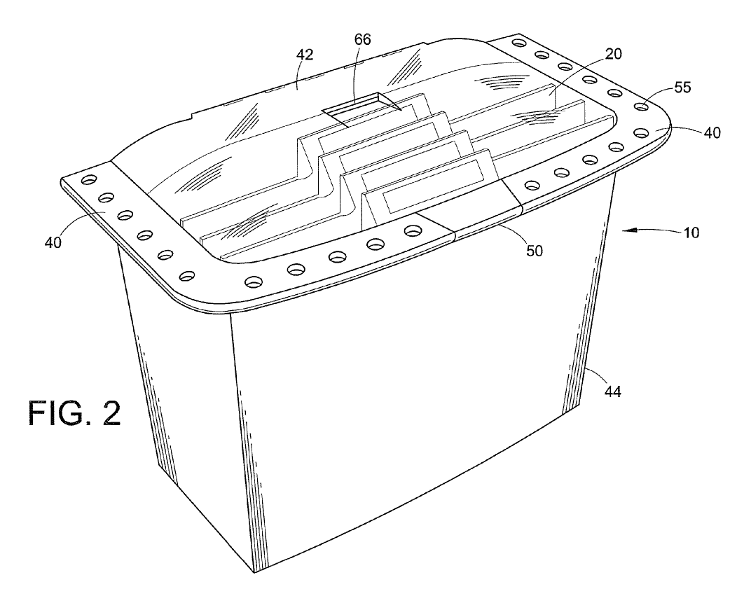

FIG. 2 illustrates an embodiment of a safety lockbox 10. The lockbox 10 secures a number of keys in a central storage bin which can closed and locked. When the lockbox is closed and locked, a person can not gain access to the keys stored in the central storage bin. A single lock can be used to effectuate a lockout and prevent a person from accessing the keys stored therein. The lockbox can accept multiple locks, wherein each of the locks needs to be removed in order to gain access to the keys within the lockbox. In addition, the lockbox provides means for organizing the keys stored within the lockbox.

The lockbox 10 shown in FIG. 2 includes a bulk storage area that can be used to house one or more key file cards 20 or individual keys 30. Use of the key file cards 20 allows the keys 30 to be stored and organized in a systematic way as discussed in further detail below.

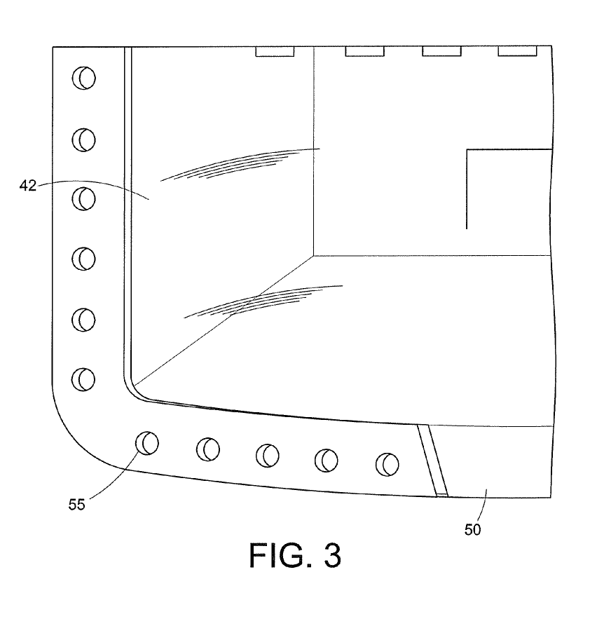

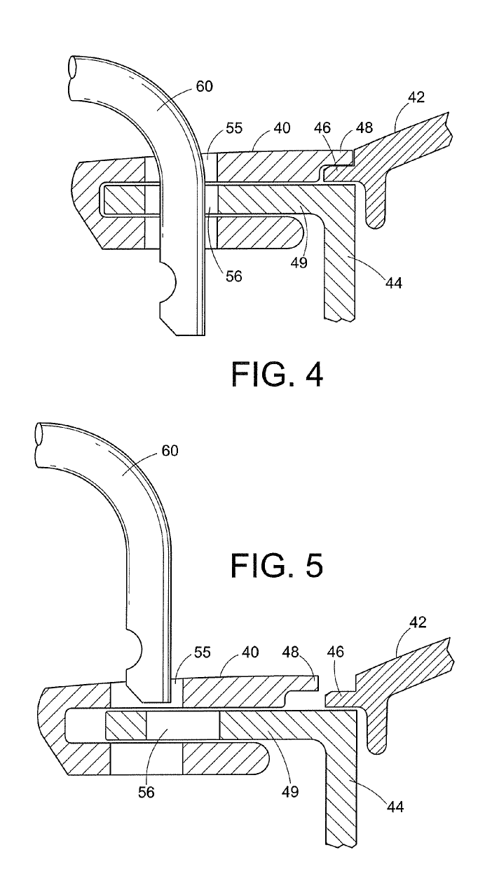

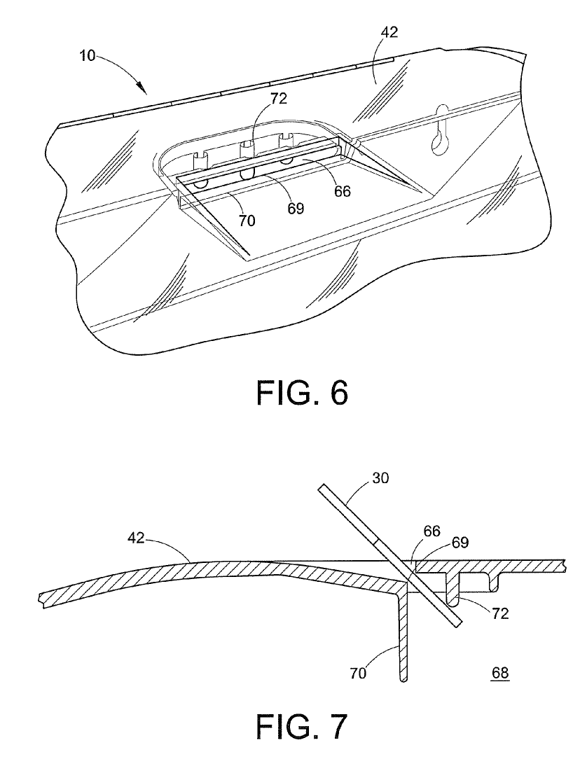

The lockbox 10 includes closure latching members 40, a cover 42 and a lower body 44. The cover 42 can either be a removable component or hingedly attached to the lower body 44, as shown in FIG. 2. The closure latching members 40 of the safety lock box 10 secure the cover 42 to the lower body 44. In order to secure the cover 42 to the lower body 44, the closure latching members secure an edge 46 on the cover 42 under flange 48 on the closure latching members 40. This is best illustrated in FIGS. 4 and 5. As shown in FIGS. 2-5, when cover 42 is closed and the latching members 40 positioned with the flange 48 over the edge 46, the closure latching members 40 captures the flange 49 on the safety lock box body 44. As shown in FIGS. 4 and 5, the closure latching members 40 secure the cover 42 to the main body 44 substantially around the periphery of the lock box and along each side of the finger grip 50.

When the closure latching members 40 are positioned to secure the cover 42 to the main body 44, the shackle holes 55 on the closure latching members 40 line up with the shackle holes 56 on the flange 49 of the safety lock box body 44. When the respective shackle holes 55, 56 align, a padlock, hasp, or other locking mechanism 60 can be placed through the shackle holes. Once the locking mechanism 60 is in place, the closure latching member 40 can not be removed or repositioned, and therefore, the cover 42 can not be opened to allow access to the keys 30 storage within the lockbox 10. Multiple sets of shackle holes 55, 56 allow for use of multiple locking mechanisms 60 on a single lockbox 10.

To open the safety lock box cover 42, all locking mechanisms 60 must be removed from the shackle holes 55, 56 and then both closure latching members 40 must be pulled outward away from the cover 42. Once the closure latching members 40 clear the edge 46 of the cover 42, the cover 42 can be opened. FIG. 5 illustrates the latch open position. As a result of opening both closure latching members 40, all shackle holes 55 on both closure latching members 40 become misaligned with all of the shackle holes 56 on the main body flange 49. When the shackle holes 55, 56 are misaligned, a locking mechanism 60 can not be placed through the holes. Furthermore, since both closure latching members 40 must be pulled outward in order to open the cover 42, a single locking mechanism 60 secured into any one set of corresponding shackle holes 55, 56 will prevent the cover 42 from being opened, regardless if one closure latching member 40 is not closed.

The safety lock box 10 may have a tinted translucent cover 42 through which key file cards 20 and keys 30 are viewable. Additionally, labels or marking can be secured to, or molded into, the cover 42 to provide additional information about the contents of the lockbox or about accessing the lockbox.

The lock box 10 may include a slot 66 for inserting keys 30 into the bulk storage area 68 within the main body 10. As shown in FIG. 7, the clearance of the key slot 66 is designed so that a key 30 must be inserted at an angle of approximately 45 degrees. The key 30 can be rotated about the lower surface 69 of the key slot 66 in order to find an angle that will allow the key 30 to slide through the key slot 66. The key slot 66 is designed with a wall 70 and a set of pins 72 arrayed around its general perimeter key slot 66. The wall and pins 70, 72, not only require a key 30 to be inserted into the slot 66 at an angle to assist in preventing accidentally placing a key 30 within the lockbox 10, but also prevent keys 30 from being removed from the lockbox 10 via tampering with the key slot 66, such as by rotating the lockbox upside-down or applying a shaking motion to the lockbox.

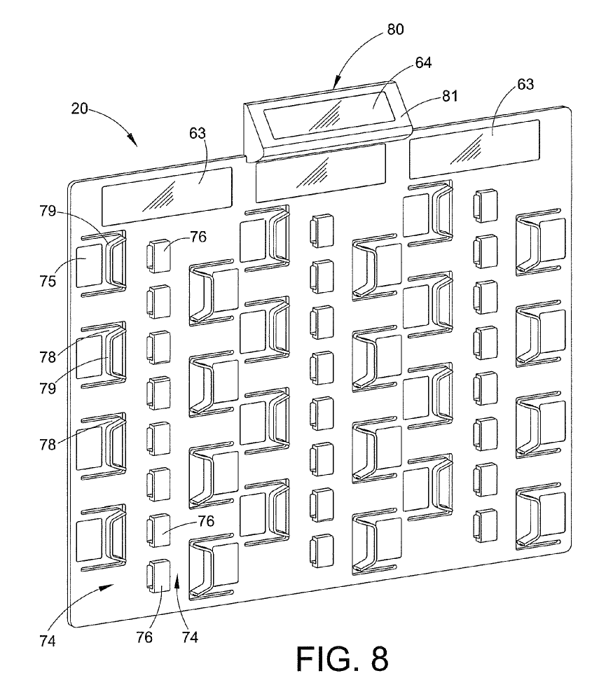

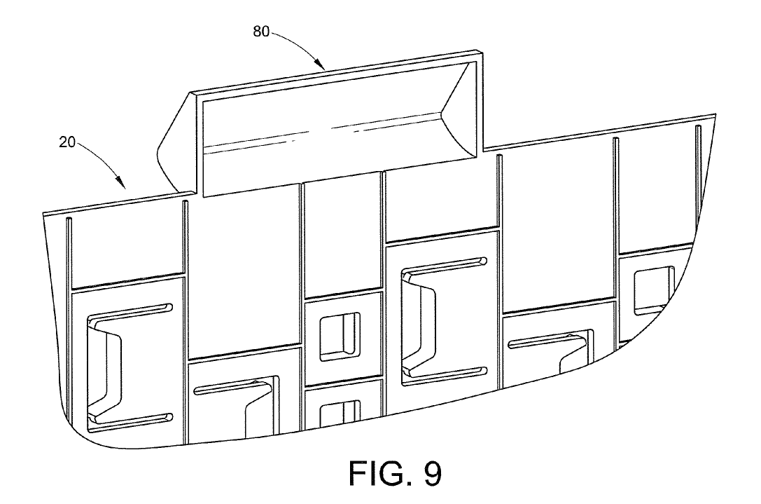

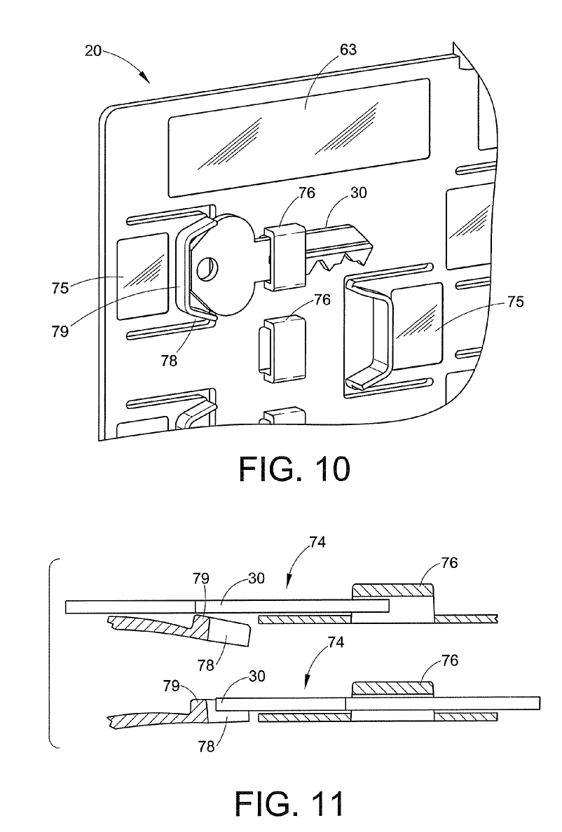

As shown in FIGS. 8-11, key file cards 20 can be used to secure and organize keys 30 in individual key holders 74, which may be individually labeled on key labels 75. In order to secure a key 30 to a key holder 74, a keys 30 is secured to the file card 20 through the use of both a sleeve 76 that accepts the key blade, and a depressible tab 78 with a raised edge 79 that frames the key head. The sleeve 76 surrounds the blade on top, sides and bottom, preventing its movement in those directions. The sleeve 76 is also sized to prevent the key head to fit therein. The raised edge 79 of the tab 78 frames the key head on both sides and the end of the key head and prevents it from moving in those directions. Once keys 30 are secured within the key holders 74, the keys can be labeled on the key labels 75. In addition, the key file card 20 can be labeled along the key column labels 63 or file card label 64 located on a front surface 81 of the handle or grip 80 located on the top portion of the key file card 20. The relationship of the raised edge 79 and sleeve 76 to each other allows for multiple sizes and shapes or keys.

To insert a key 30 into a key holder 74, the tab 78 is depressed and the key 30 is slid past the tab 78, blade first, into the key blade sleeve 76 until the head passes the edge 79 of the tab 78. As shown in FIG. 11, the tab 78 is then released to block the reverse movement of the key 30. To remove a key 30, the tab 78 is first depressed, and the key 30 is slid backwards, out of the sleeve 76 and past the depressed key head tab 78.

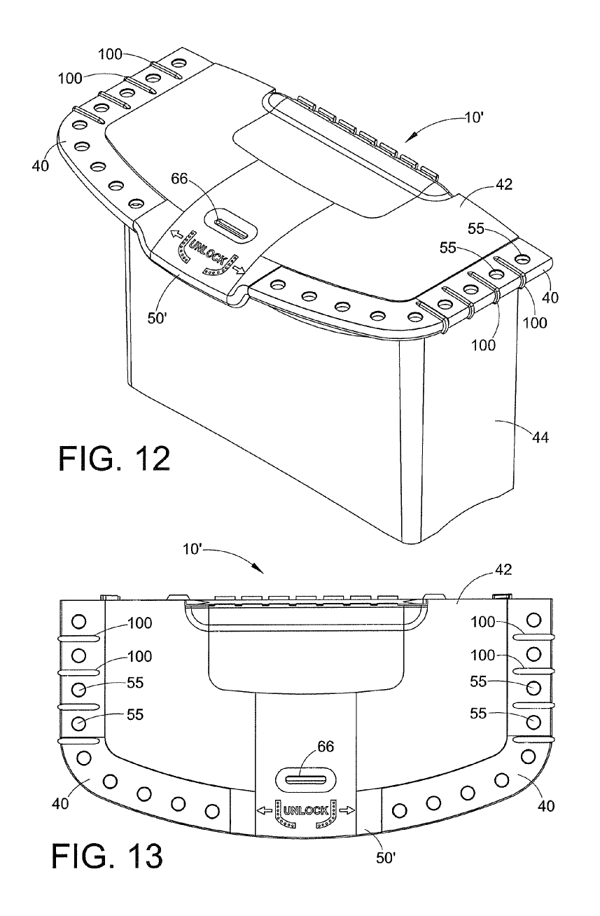

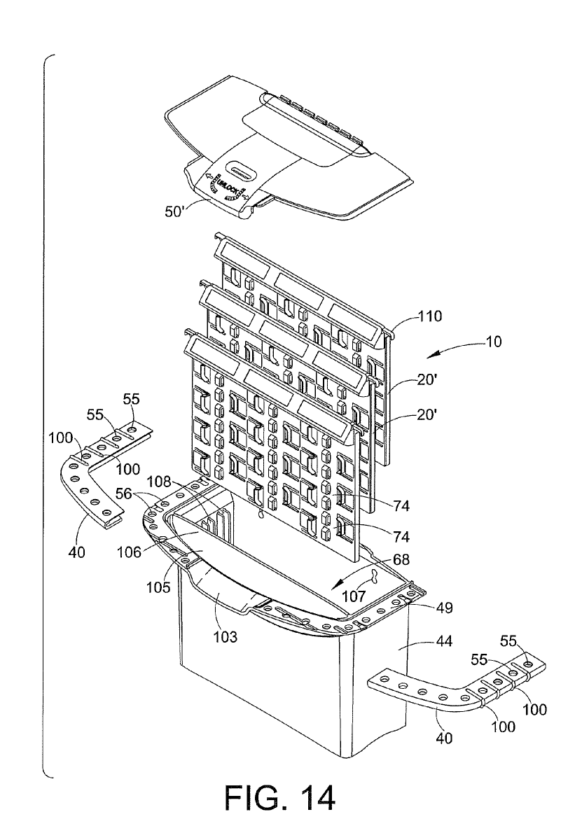

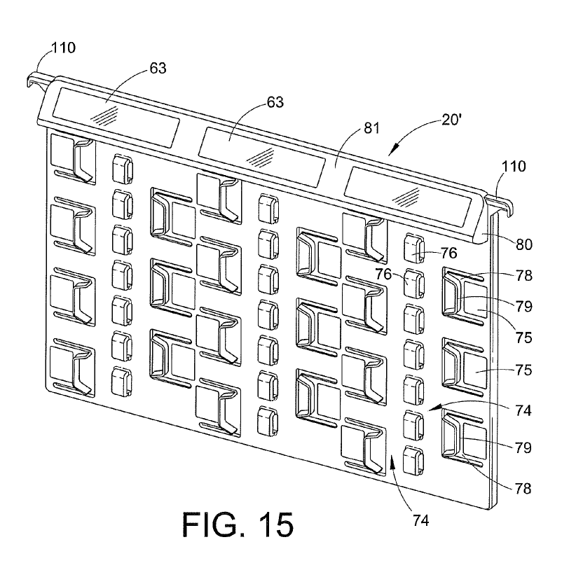

FIGS. 12-15 illustrate another embodiment of the lockbox 10′ and key card 20′. The basic operation of the lockbox 10′ and key card 20′ is the same as the previous embodiment with modifications. First, finger grip 50 has been replaced with an enlarged handle 50′ to provide for easier movement of the lockbox 10′. Other gripping features, such as grips 100 or molded handle 103, can be added to further assist in the grabbing and movement of the lockbox 10′. Second, the key slot 66 has been moved to the front section of the cover 42 so that keys 30 dropped through key slot 66 drop into the key area 105 which is separated from the bulk storage area 68 by wall 106. Third, wall mount holes 107 were added. Fourth, grooves 108 were added to the inner side walls of the main body 44 to allow the file cards 20′ to slide into place. Fifth, the key file cards 20′ were adapted to allow for storage in standard filing cabinets by adding hooks 110 on either side of the key file card 20′. Lastly, the key column labels 63 were moved to the front surface 81 of the handle 80. One skilled in the art should appreciate that these modifications can be made individually or in subcombinations to provide additional embodiments.

The invention has been described with reference to the preferred embodiments. Clearly, modifications and alterations will occur to others upon a reading and understanding of this specification. It is intended to include all such modifications and alterations insofar as they come within the scope of the appended claims or the equivalents thereof. The scope of the invention and claims are not limited in any way by the description of the preferred embodiments, which are provided only to illustrate various examples of the invention.

1. A lockbox comprising: a body defining a storage area therein; a cover selectively securable to said body to completely enclose said storage area; and one or more closure latching members that interact with an edge on said cover and a flange on said body to secure said cover to said body.

2. The lockbox of claim 1, wherein said one or more closure latching members further comprise a plurality of shackle holes that align with a set of shackle holes on said flange of said body when said one or more closure latching members are in an engaging position.

3. The lockbox of claim 1, wherein said cover is hingedly secured to said body.

4. The lockbox of claim 1, wherein said cover includes a key slot for dropping keys into said storage area.

5. The lockbox of claim 4, wherein said key slot includes one or more members that requires a key to enter said key slot at an angle.

6. The lockbox of claim 1, wherein said storage area is divided by a wall thereby forming two separate storage areas.

7. The lockbox of claim 6, wherein said two separate storage areas include a first storage area for storing one or more key file cards and a second storage area for storing one or more individual keys.

8. The lockbox of claim 7 further comprising a key slot for dropping keys into said second storage area.

9. The lockbox of claim 1 further comprising one or more gripping features.

10. A key storage and organization unit comprising: (a) a lockbox comprising:(i) a body defining a storage area therein; (ii) a cover selectively securable to said body to completely enclose said storage area; and (iii) one or more closure latching members that interact with an edge on said cover and a flange on said body to secure said cover to said body; and (b) one or more key file cards.

11. The key storage and organization unit of claim 10, wherein said one or more closure latching members further comprise a plurality of shackle holes that align with a set of shackle holes on said flange of said body when said one or more closure latching members are in an engaging position.

12. The key storage and organization unit of claim 10, wherein said cover includes a key slot for dropping keys into said storage area.

13. The key storage and organization unit of claim 12, wherein said key slot includes one or more members that requires a key to enter said key slot at an angle.

14. The key storage and organization unit of claim 10, wherein said storage area is divided by a wall thereby forming two separate storage areas: a first storage area for storing said one or more key file cards and a second storage area for storing one or more individual keys.

15. The key storage and organization unit of claim 10, wherein said one or more key file cards include a plurality of key holders.

16. The key storage and organization unit of claim 15, wherein each of said plurality of key holders includes a sleeve for retaining a key blade and a tab for retaining a key head.

17. The key storage and organization unit of claim 10, wherein said one or more key file cards include a set of hooks that allow said one or more key file cards to be hung in a conventional file cabinet drawer.

18. A lockbox comprising: a body defining a storage area therein; a cover selectively securable to said body to completely enclose said storage area, wherein said cover includes a key slot for dropping keys into said storage area; and one or more closure latching members that interact with an edge on said cover and a flange on said body to secure said cover to said body.

19. The lockbox of claim 18, wherein said key slot includes one or more members that requires a key to enter said key slot at an angle.

20. The lockbox of claim 18, wherein said storage area is divided by a wall thereby forming two separate storage areas: a first storage area for storing one or more key file cards and a second storage area for storing one or more individual keys.
